(19) United States
(12) Patent Application Publication
(10) Pub. No.: US 2026/0229163 A1
(43) Pub. Date: Aug. 6, 2026

(54) EMBEDDING PANEL-SPECIFIC DISPLAY INFORMATION FOR DISPLAY PANELS

(71) Applicant: HYPHY USA Inc., San Jose, CA (US)

(72) Inventor: Alex HENZEN, NM Bladel (NL)

(21) Appl. No.: 19/465,613

(22) Filed: Jan. 30, 2026

Related U.S. Application Data
(60) Provisional application No. 63/964,812, filed on Jan. 21, 2026.
(60) Provisional application No. 63/754,069, filed on Feb. 5, 2025.

(51) Int. Cl. G09G 3/20

(52) U.S. Cl. CPC G09G 3/2096; G09G 2320/0233; G09G 2320/0673

(57) ABSTRACT

A panel assembly intended to be combined within a display unit has no timing controller but includes a non-volatile memory device for storing panel-specific information of its display panel. The manufacturer of the display panel stores a panel defect table, a mura correction table, a sub-pixel correction table, a gamma correction table, panel resolution or other data in the memory device during manufacture of the panel assembly. During final assembly of the display unit, the panel assembly is connected to the system-on-chip; at power-on, the system-on-chip transfers data from the memory device to itself and stores any tables or data within the system-on-a-chip, within a downstream transmitter if present, or in other locations to perform image processing upon incoming samples. Alternatively, these tables or data are stored within a USB drive or file which is delivered to the display unit manufacturer for transfer to the system-on-a-chip and storage as described.

### CROSS REFERENCE TO RELATED APPLICATIONS

This application claims priority to U.S. provisional patent application No. 63/754,069 (Docket No. HYFYP019P) filed February 5th, 2025, entitled “ Embedding panel-specific display information for display panels " and to U.S. provisional patent application No. 63/964,812 (Docket No. HYFYP021P) filed January 21 st , 2026, entitled “ ANALOG VIDEO TRANSPORT TO A DISPLAY PANEL IMPROVEMENTS ,” both of which are hereby incorporated by reference.

### FIELD OF THE INVENTION

The present invention relates generally to panel-specific information of display panels. More specifically, the present invention relates to storage of such information within a panel assembly.

### BACKGROUND OF THE INVENTION

Display panels for displaying images, video, documents, etc. are used in televisions, monitors, kiosks, billboards, signs, and other such large display units and devices, as well as in smaller display units such as in desktop computers, laptops, tablet computers, smartphones, etc.

The panel-specific information for display panels is typically stored in an integrated circuit embedded within the timing controller (T-Con). This IC contains important configuration data or other proprietary panel settings that define each individual panel’s characteristics. For optimal display configuration, this information includes a panel defect table (among other tables) which is used at various times to ensure accurate color representation and optimal visual quality. The information in this panel defect table may be used by the T-Con during display operation in order to mask defects and to compensate for uniformity.

Typically, a display panel manufacturer will manufacture (or assemble) what is termed the "panel assembly" which includes the display panel itself, source drivers, gate drivers, the T-Con and other associated integrated circuits, as well as the necessary printed circuit boards, cabling and frame to hold the panel assembly together. Because the display panel manufacturer is aware of the unique defects and characteristics of each individual panel it produces (indeed, is aware of each pixel within that panel), it is relatively straightforward for that manufacturer to embed those panel-specific characteristics into the T-Con. A television manufacturer (or any manufacturer of a display unit or other device that includes the panel assembly) will assemble the final display unit that includes a system-on-a-chip (SoC) or a display controller that communicates with the T-Con. Because the panel-specific information is included within the T-Con, and because the T-Con (or perhaps the source drivers) uses that information to perform the image processing, is not necessary for a television manufacturer to have that panel-specific information, nor for a panel manufacturer to worry about the logistics of how to transfer this information for an individual panel assembly to the television manufacturer.

Currently, however, there is a trend for the T-Con (or its functionality) to be integrated within the SoC (or within the display controller) that are within the control of the television manufacturer. This means that the panel-specific information, which can be proprietary, must now be somehow transferred to the television manufacturer (who may be in a different country) and embedded within the SoC at the time of the television final assembly. Apart from creating logistical issues (making sure that this panel-specific information ends up with the correct panel assembly), this information may be confidential information that the panel manufacturer does not wish to disclose nor make public.

Accordingly, a new system and method are desired that will allow for panel-specific information to be accessed and used seamlessly for each individual display panel when in operation, and that will reduce logistical complexity and preserve the confidential information of the panel manufacturer.

### SUMMARY OF THE INVENTION

To achieve the foregoing, and in accordance with the purpose of the present invention, a memory device is disclosed that stores panel-specific information when a timing controller is not present within the panel assembly.

As mentioned above, typically panel-specific information was stored within or at the timing controller (T-Con) located within the panel assembly and the T-Con performed image processing using that information. But, as the functionality of that T-Con migrates back into the system-on-chip (SoC) (or into a display controller) and the T-Con as a separate IC ceases to exist, a technique for allowing the SoC (or display controller) to access that panel-specific information and to perform that image processing is needed. Accordingly, a memory device located within the panel assembly stores that panel-specific information and makes it available over a wire or cable for transfer to the SoC.

The invention provides a small amount of non-volatile memory containing the panel-specific information (which may include gamma correction data, panel defect tables, full mura correction tables, etc.). The maximum size of such a memory device may be up to around 100 MB (or more) if a full sub-pixel correction table is embedded but will typically be about 100 kB in size. This memory can be accessed from the interface cable by a simple serial interface. Reading the information is only necessary at power-up (or even only once after assembly). The information stored can be encrypted in such a way that the plaintext information cannot be read directly from the memory without having a decryption key. Decryption then takes place in the SoC.

In a first embodiment, a panel assembly includes a display panel and a non-volatile memory device that stores panel-specific information, but does not include a timing controller. An electromagnetic pathway connects the memory device with a connector of the panel assembly.

In a second embodiment, a display unit (e.g., the complete television, monitor or other device) includes a panel assembly having a display panel and a non-volatile memory device that stores panel-specific information but does not include a timing controller. The main board includes a system-on-chip with timing control functionality and an electronic pathway connects the memory device to the system-on-chip.

In a third embodiment, a method includes connecting a first electromagnetic pathway to a panel assembly of a display unit, the panel assembly having a display panel and a non-volatile memory device that stores panel-specific information but does not include a timing controller. Next, the other end of the electromagnetic pathway is connected to the main board of the display unit that includes a system-on-chip with timing controller functionality.

In a fourth embodiment, a method includes receiving a panel assembly of a display unit that includes a display panel but does not include a timing controller. An electronic file or a portable non-volatile storage device is also received that includes panel-specific information of the display panel. The panel-specific information is transferred into a system-on-chip of the display unit. The system-on-chip stores the panel-specific information within memory of the system-on-chip.

### BRIEF DESCRIPTION OF THE DRAWINGS

The invention, together with further advantages thereof, may best be understood by reference to the following description taken in conjunction with the accompanying drawings in which:

FIG. 1 is a block diagram of a prior art display unit.

FIG. 2 is a block diagram of a display panel of a panel assembly of a display unit.

FIG. 3 is a block diagram showing the various tables that may be stored within memory device.

FIG. 4A illustrates one technique for connecting the electromagnetic pathway from the memory device to the SoC.

FIG. 4B illustrates another technique for connecting the electromagnetic pathway from the memory device to the SoC.

FIG. 5 is a block diagram of a display unit in which analog data is sent to the source drivers from a transmitter.

FIG. 6 is a block diagram showing the various tables that may be stored within memory device.

FIG. 7 is a flow diagram describing an embodiment in which panel-specific information is made available to a system-on-chip of a display unit.

### DETAILED DESCRIPTION OF THE INVENTION

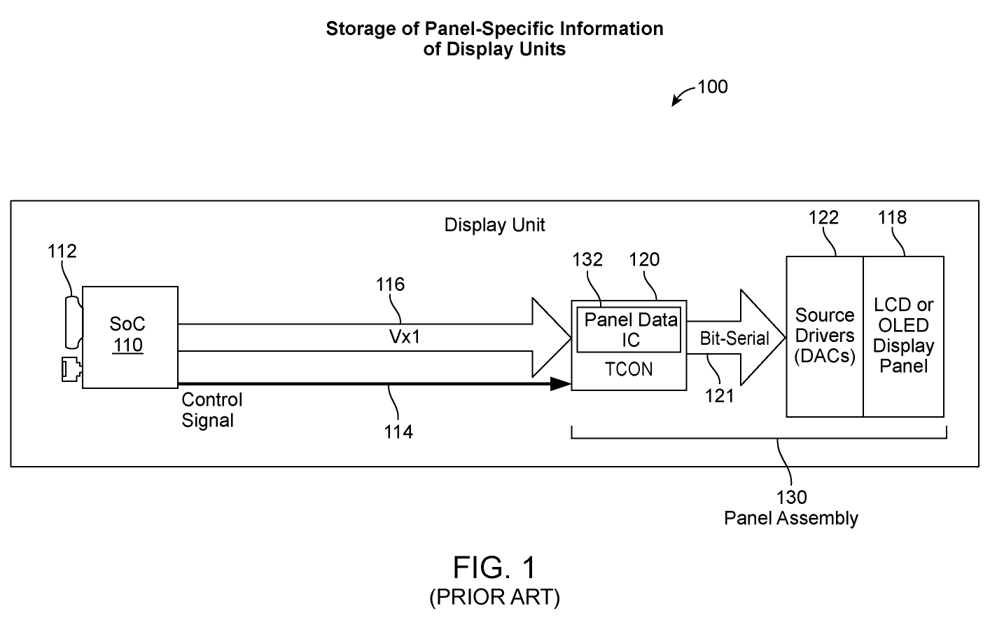

FIG. 1 is a block diagram of a prior art display unit 100. For purposes of this disclosure, "display panel" refers to that interior portion of a display unit that implements pixels that produce light for viewing, typically a glass substrate having various layers upon which transistors are formed; “panel assembly” refers to the collection of the display panel, source drivers, gate drivers and associated electronics and cabling that is produced and under control of a panel manufacturer; and "display unit" refers to the entire (typically) rectangular enclosure that includes the display panel, panel assembly, a frame, cabling, and associated electronics for producing video images for a consumer. Examples of display units include televisions, monitors, kiosks, billboards, signs, and other such large displays, as well as smaller items such as desktop computer screens, laptop computers, tablet computers, smartphones, mobile devices and other similar devices, etc.

Shown is an input of a digital video signal 112 into the display unit 100 via an HDMI connector (or RJ45 connector, etc.) to a system-on-a-chip (SoC) 110 of the display unit. SoC 110 transports the digital signal via a V-by-One HS standard 116 to a timing controller 120 (T-Con) which then uses bit-serial transport 121 (e.g., SerDes, LVDS or CEDS) to any number of DACs (digital-to-analog converters) 122 within the source drivers connected to the display panel 118 in order to convert the digital signal into analog for input into pixels of the display panel. A control signal 114 provides video framing flags (Vsync, Hsync, etc.), configuration parameters, gate driver control signals, FRC grayscale, driver parameter settings, backlight control, contrast control, etc. As mentioned above, panel assembly 130 encompasses T-Con 120, source drivers 122 and the panel itself 118, i.e., those components manufactured by (or assembled by) and under control of a display panel manufacturer.

Panel data IC 132 is non-volatile memory typically integrated within T-Con 120 that includes the panel-specific information (such as the panel defect table mentioned above) and which is used by the T-Con to perform image processing during operation of the display unit. As the display panel, source drivers and T-Con are all part of the same manufacturing cycle, it is a straightforward matter for the panel manufacturer to store the panel-specific information into this panel data integrated circuit 132. This integrated circuit may also be a discrete component separate from, but in communication with, the T-Con and also located within the panel assembly. As mentioned above, as the functionality of the T-Con becomes integrated with the SoC, it can be problematic to transfer that panel-specific information from the panel manufacturer to the television manufacturer. In order to address the above deficiencies in the prior art, a technique for storing and accessing panel-specific information is described below.

### Storage of Panel-Specific Information for Display Units Sending Digital Video Samples from the System-on-Chip

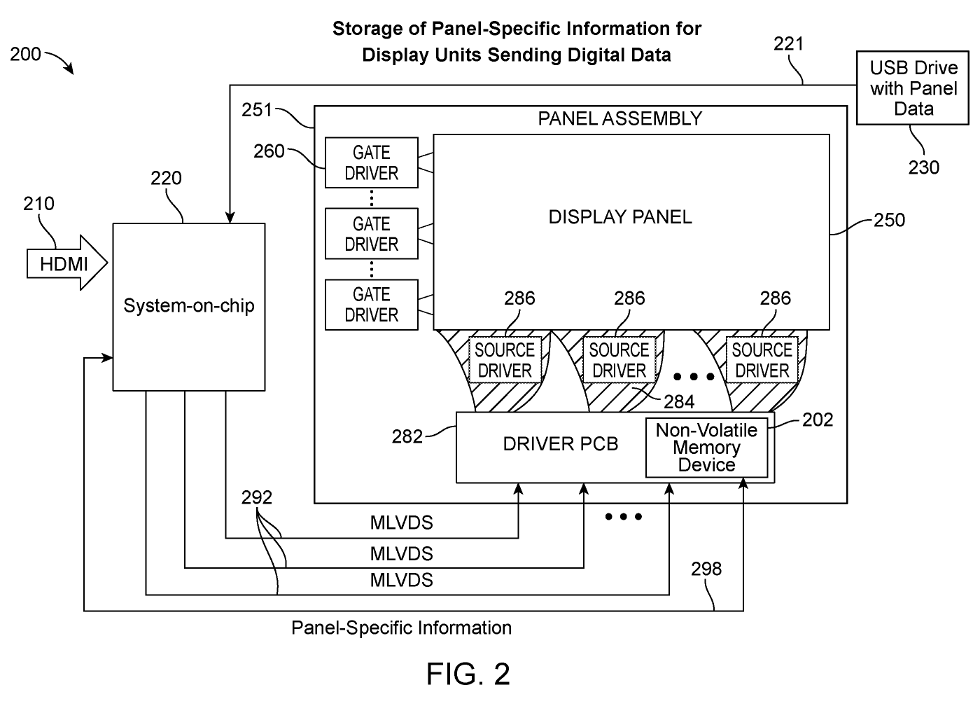

FIG. 2 is a block diagram of a display panel 250 of a panel assembly 251 of a display unit 200. Shown is a digital video signal 210 being delivered to the display unit using an HDMI interface (an LVDS, HDBaseT, MIPI, IP video, etc., interface may also be used). Shown generally is the system-on-chip (SoC) 220 which delivers digital video samples from the video signal to the panel assembly 251. In this example of FIG. 2, the display panel 250 may be a display panel of any size such as a monitor, large-screen television, billboard, scoreboard, computer, tablet or telephone display, or may be a display or displays within a VR headset, etc.

Various of the high-speed serial links over HDMI, DisplayPort or between integrated circuits to or within a display unit send digital video as a differential 8b10b signal. Note that encoding other than 8b10b may also be used, e.g., HDMI 2.1 or 2.2 uses a mode called Fixed Rate Link (FRL) which uses 16b18b encoding, and DisplayPort uses 128b132b encoding. These other encoding schemes are used to pack more bits onto a given wire or wires.

The functionality of the T-Con is now within the SoC (i.e., there is no separate T-Con integrated circuit produced along with the panel assembly) which also performs functions such as reverse compression, etc., and outputs the video signals via MLVDS channels 292 (or other suitable interface) to the panel assembly 251. It is contemplated that a separate and discrete display controller may receive digital video from the SoC 220, and it may be the separate display controller that actually outputs the video signals to the panel assembly; in this disclosure we simply refer to the SoC 220 as outputting the video signals, whether it is an SoC that incorporates a display controller or an SoC that outputs to a separate display controller which then outputs to the panel assembly.

Typically, MLVDS, V-by-One HS or Embedded DisplayPort (eDP) will be used to deliver the digital video data 292 from the SoC 220 to the PCB 282 and then on to source drivers 286. If via MLVDS pairs (for example), the number of pairs is implementation specific and depends upon the data rate per pair as well as upon panel resolution, frame rate, bandwidth etc. Included are a rigid driver PCB 282 as well as individual flexible PCBs 284 each holding a source driver 286 which generate source voltages for the display panel. Gate drivers 260 may be implemented as known in the art and generation of the gate driver control signals (not shown) may be performed by the timing controller as is known in the art (or by other specific hardware) and may be based on synchronization information from the source drivers.

During operation, a stream of digital video samples 210 containing color values and pixel-related information is received from a video source at display unit 200 and delivered to the SoC 220. The number and content of the input video samples received from the video source depends upon the color space in operation at the source (and the samples may be in black and white). Regardless of which color space is used, each video sample is representative of a sensed or measured amount of light in the designated color space. The exposed color information for each set of samples can be any color information (e.g., Y, C, Cr, Cb, etc.) and is not limited to RGB. Use of color information other than RGB sub-pixels may require additional processing before the source drivers can drive the columns (which are natively sub-pixel intensity values). The number of output sample values S in each set of pixel samples is determined by the color space applied by the video source. With RGB, S=3, and with YCbCr 4:2:2, S = 2. In other color spaces, the sample values S in each set of samples may be just one or may be more than three. Framing information and framing flags may also arrive with the input video samples and their processing and use may be implemented as is known in the art.

As there is no separate T-Con in this embodiment, the panel-specific information that used to be held within it needs to be placed somewhere else and made accessible to the SoC 220. Accordingly, a memory device 202 is shown mounted on the driver PCB 282 and is preferably a non-volatile memory that holds certain panel-specific information as herein described and is used by the display panel or panel assembly manufacturer to store the panel-specific information of which it is aware. In this fashion, memory device 202 may be later accessed by the SoC 220 in order to perform image processing on the incoming video samples without the display panel manufacturer concerning itself with the logistics of transferring that information to a separate party nor with confidentiality of the information.

Instead of being mounted directly on PCB 282, this memory device may also be mounted within any portion of the panel assembly 251 that is controlled by the panel assembly manufacturer. Preferably, the memory device may be located anywhere on the driver PCB, either through a connector or mounted directly thereon. Since the data will be transferred electronically following display characterization, the most cost-effective way is to have a fixed device (e.g., a non-volatile memory) on the PCB. In one specific embodiment, memory device 202 is an EEPROM (Electrically-Erasable Programmable Read-Only Memory) chip, but may also be implemented as a Programmable Read-Only Memory (PROM) chip (write once), or similar devices.

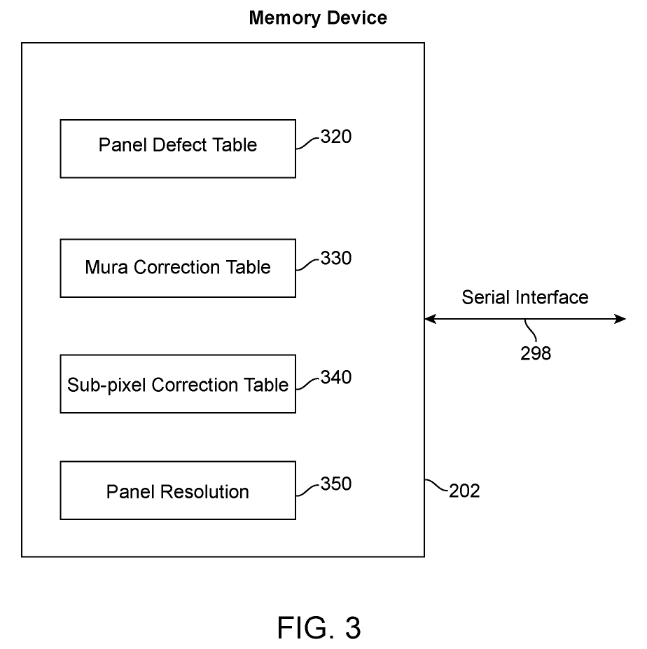

Depending upon which panel-specific tables are stored within memory device 202 (explained below with reference to FIG. 3), the SoC 220 (or a processor in connection with and controlled by the SoC) will request the data stored within these tables via a serial interface 298 and then perform image processing using these tables before the digital samples are then transmitted to the source drivers.

As known in the art, there are two types of gamma correction used in a display unit (both referred to as “gamma correction,” but they perform different functions). A first type performs a linearization of the optical response to the input signal (because LCDs do not respond linearly to a driving signal and our eyes do not respond linearly to the number of photons received). This gamma correction is typically handled in the legacy display driver IC. The second type of gamma correction performs adjustment of color temperature and HDR. This is a small adjustment to the linear behaviour achieved by the first gamma correction and is usually always handled by the SoC. Reference to “gamma” or “gamma correction” herein refers to the first type.

In this embodiment, gamma correction (adjustments applied to the brightness and color of an image in order to match how humans perceive light and color) may still be performed within the source drivers and as such its data need not be stored within memory device 202. As is known, gamma correction helps to ensure that the shades from black to white are displayed consistently and accurately, with smoother transitions between different brightness levels. Gamma correction modifies the input signals of a display using a non-linear operation to create a linear luminance response to the input signal.

As shown, an electromagnetic pathway 298 provides communication between memory device 202 and the SoC 220. Because panel assembly 251 is manufactured separately, and in a different location, from SoC 220 and the rest of the display unit, pathway 298 may include multiple portions as described below. During the final assembly of the display unit, the multiple portions are connected using connectors.

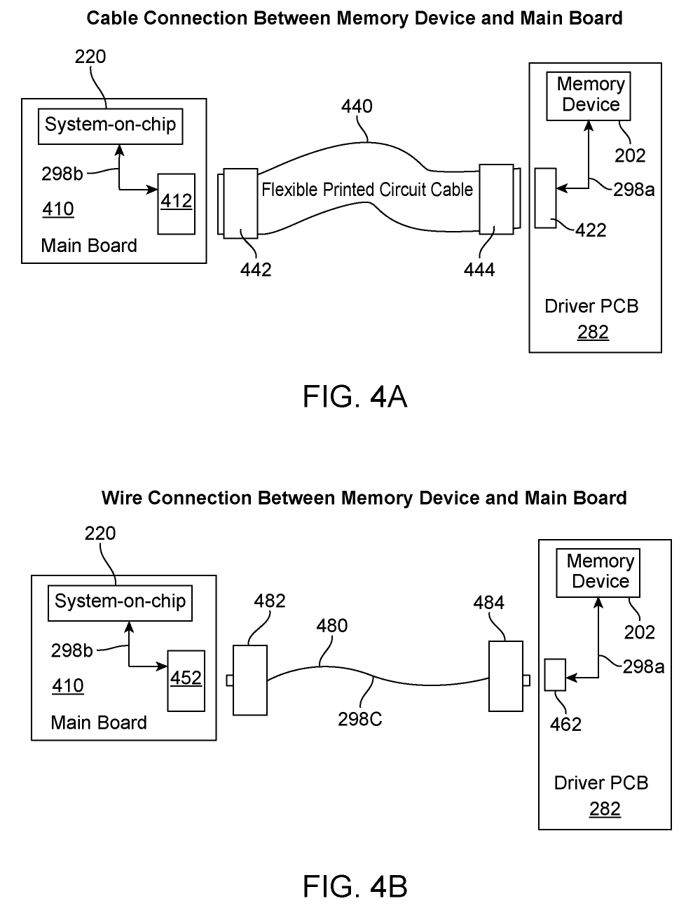

In a further embodiment, instead of using memory device 202 in order to store the panel-specific information, the panel assembly manufacturer stores the panel-specific information on a USB drive 230 (also referred to as a flash drive, thumb drive, memory stick, etc.), generally, any small, portable non-volatile memory device that can store the panel-specific information and then be transported to the display unit manufacturer for final assembly. Or, instead of a USB drive 230, the panel assembly manufacturer stores the panel-specific information into an electronic file of a computer which is then transported, sent or delivered via electronic mail, file transfer, uploading and downloading, etc. to the display unit manufacturer. Once the panel data is stored on drive 230 and shipped 221 to the display unit manufacturer, during final assembly the manufacturer reads the panel data from drive 230 (or from an electronic file, as the case may be) and stores the applicable tables into the SoC or with the timing controller functionality as described herein. In this embodiment, the connections of FIG. 4A and 4B are not needed.

FIG. 3 is a block diagram showing the various tables that may be stored within memory device 202. A serial interface 298 may be used to access each of the tables 320, 330, 340 or values 350 within the memory device in order to transfer the data of each table to the SoC 220 when requested. Such an interface and its method of access may be implemented as known to those of skill in the art. In this embodiment, gamma correction data is not stored within the memory device.

A panel defect table 320 stores data that details known imperfections or anomalies present in a display panel 250, such as dead pixels, sub-pixel defects, or areas with irregular brightness or color uniformity. This table helps the display controller (or SoC or other processing unit) manage and compensate for these defects, ensuring better image quality and minimizing visual impact. The panel defect table 320 is used during display operation to mask defects in certain pixels or sub-pixels to make defects less noticeable to the viewer, and to compensate for uniformity by ensuring consistent brightness and color even in areas with minor manufacturing imperfections.

A mura correction table 330 is a set of data used to address and correct mura (i.e., Japanese for "unevenness," using a process or technology called “demura”) which are inconsistencies or unevenness in the brightness and color uniformity across an LCD or OLED display panel 250. These imperfections can result in visible patches or patterns on the screen, often referred to as "clouding" or "blotches." The mura correction table 330 provides the SoC with the necessary adjustments to compensate for these irregularities, improving the display panel's uniform appearance and overall image quality. It allows the SoC to make pixel-level or region-specific adjustments to brightness and color to minimize visual irregularities.

While both tables are part of the panel-specific information for display panel 250, the mura correction table 330 focuses on correcting uniformity and subtle visual inconsistencies across the entire display, whereas the panel defect table 320 is aimed at tracking and handling more distinct and isolated defects, such as faulty pixels.

A sub-pixel correction table 340 is a detailed dataset used to correct issues at the sub-pixel level within display panel 250 and is often termed a full sub-pixel correction table. Each pixel on an LCD or OLED display is composed of sub-pixels, typically red, green, and blue, that combine to produce a range of colors. This correction table provides information to the SoC on how to adjust the behavior of individual sub-pixels to ensure consistent color accuracy and brightness across the display panel. This table complements both the panel defect table and the mura correction table by providing finer, more detailed corrections that contribute to uniformity and visual consistency. All three tables may be used in conjunction to ensure optimal display performance. The panel defect table handles major flaws, the full sub-pixel correction table fine-tunes individual sub-pixels, and the mura correction table smooths out large-scale inconsistencies.

Panel resolution 350 refers to the number of distinct pixels that make up the display area of the actual display panel or screen. It is typically expressed as the number of pixels horizontally by the number of pixels vertically. For example, “1920 × 1080,” this means that the panel has 1920 pixels across the width and 1080 pixels along the height, commonly known as Full HD (FHD). Or, “3840 × 2160,” this is referred to as 4K Ultra HD (UHD), with four times the resolution of 1080p. Higher resolutions generally result in sharper and clearer images, as there are more pixels to display fine details. The resolution also influences the screen's aspect ratio (the proportional relationship between width and height), which is commonly 16:9 for most modern displays and which may also be included with the panel resolution.

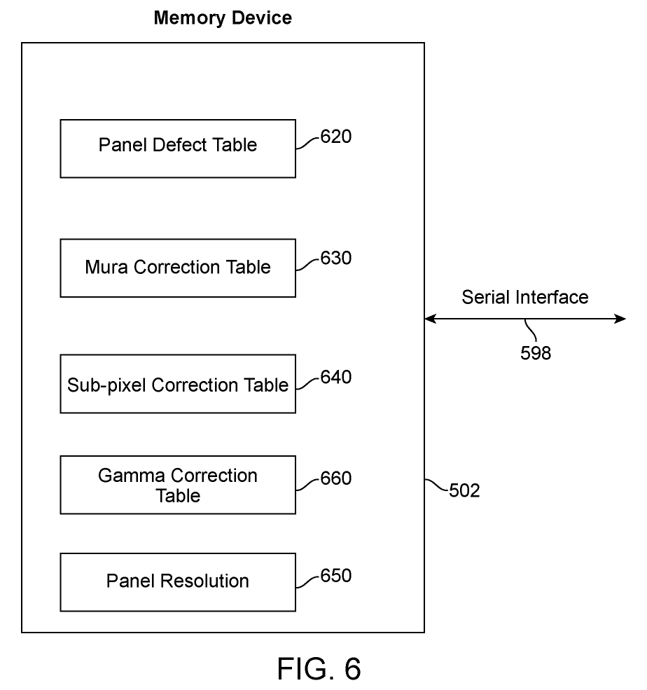

These three tables store digital data and operate in the digital domain, i.e., they perform their processing digitally within a display controller or image processing unit (typically within a system-on-chip) for modern devices like smartphones, tablets, and laptops), within a dedicated display controller or timing controller (for high-end televisions, monitors, and specialized display panels). As mentioned above, in this embodiment gamma correction data may be present within the source drivers 286 and applied as is known in the art (e.g., using a resistor ladder), in which case the gamma correction data need not be stored in memory device 202. Thus, gamma correction may be performed at the source drivers and the correction data need not be moved to the system-on-chip. Nevertheless, in another embodiment described below in FIG. 6, a gamma correction table may be present in the memory device. In addition, other tables or data may be stored within this memory device for transfer to the final assembly of the display unit. For example, data such as driving voltage, temperature dependence profiles, backlight configuration, panel resolution, maximum or minimum frame rate, bit depth, etc. all may be stored on the memory device and transferred as disclosed herein to the SoC. Typically, the SoC will access the basic properties of the display panel in order to understand to which display it is connected, in order to use the correct output signals.

In addition to these various tables that may be stored within memory device 202, other configuration data that help define a particular display panel's characteristics may also be stored in the memory device such as those described above.

### Connection Interface

FIG. 4A illustrates one technique for connecting the electromagnetic pathway 298 from the memory device 202 to the SoC 220. Depending upon the particular implementation, electromagnetic pathway 298 may be a single wire or multiple wires. In this embodiment, the existing interface cable 440 for transporting video samples is used to implement pathway 298.

Shown is SoC 220 which is typically mounted upon a printed circuit board such as main board 410 and having a rigid female connector 412 mounted on the main board. Similarly, driver PCB 282 upon which memory device 202 is mounted includes a rigid female connector 422 mounted on the board. Shown is a flexible printed circuit (FPC) interface cable 440 (a flat, thin, flexible ribbon cable) having a rigid male connector 442 and 444 at each end; cable 440 is shown about to be connected to female connectors 412 and 422 during final assembly. Pathway 298 is now comprised of three separate but electrically connected pathways, path 298a, path 298b, and a path within cable 440 consisting of a wire or wires. Thus, pathway 298 is integrated within the normal interface cable used to connect the SoC to the source drivers of the panel assembly. Although not shown, the video samples are also transported from the SoC to the source drivers using cable 440 as is known in the art.

Although not shown, cable 440 may also be implemented as traces on circuit boards as is known in the art. And, the interface cable or traces may be structured using differential pairs or single wires for transmitting data. The FPC may also be implemented as a flat flexible cable (FFC), custom high-speed connectors designed for specific signaling protocols, or an embedded PCB combination in which metallic traces of the panel assembly directly line with metallic traces on the SoC mainboard via a direct connector, eliminating the need for intermediate cables. Further, connector 422 may attach directly to the glass substrate of the display or to a small printed circuit board near the edge of the display, and may be a zero-insertion-force (ZIF) connector, a small edge connector, contact pads, or similar. Connector 412 has a matching connector that interfaces with the other end of cable 440. Further, instead of a mechanical connection between metallic traces of the panel assembly and the main board, direct bonding techniques such as ACF or soldering may be used, or a flexible PCB extension may be used in order to integrate the panel assembly wiring seamlessly with the main board.

The video samples are also transported from the SoC to the source drivers using cables or traces as is known in the art. And, although connectors 412 and 422 are shown being located in particular locations, they may be located in other locations as is known in the art. In this implementation, connectors 412 and 422 are shown being part of the PCB 282 or form part of a printed circuit board upon which the SoC 220 is mounted.

FIG. 4B illustrates another technique for connecting the electromagnetic pathway 298 from the memory device 202 to the SoC 220. Depending upon the particular implementation, electromagnetic pathway 298 may be a single wire or multiple wires. In this embodiment, a single wire may be used, such as “1-Wire,” which is a wired half-duplex serial bus designed by Dallas Semiconductor that provides low-speed data communication and supply voltage over a single conductor . Other, more complex interfaces (such as RS422) are faster and may also be used. An interface speed of about 400 Mbps or greater may be needed depending upon the number of tables stored and their sizes. The interface IEEE 1394 will also work. Preferably, the protocol used for communication of data from the memory device uses a low-frequency serial communication; other techniques such as I2C or JTAG may also be used.

Shown is SoC 220 which is typically mounted upon main board 410 and having a rigid female connector 452 mounted on the main board. Similarly, driver PCB 282 upon which memory device 202 is mounted includes a rigid female connector 462 mounted on the board. Shown is a single wire (or multiple wires) 480 having a rigid male connector 482 and 484 at each end; cable 480 is shown about to be connected to female connectors 452 and 462 during final assembly. Pathway 298 is now comprised of three separate but electrically connected pathways, path 298a, path 298b, and a path 298c consisting of wire or wires 480. Although not shown, the video samples are also transported from the SoC to the source drivers using cables or traces as is known in the art.

### Storage of Panel-Specific Information for Display Units Sending Analog Video Samples from the System-on-Chip

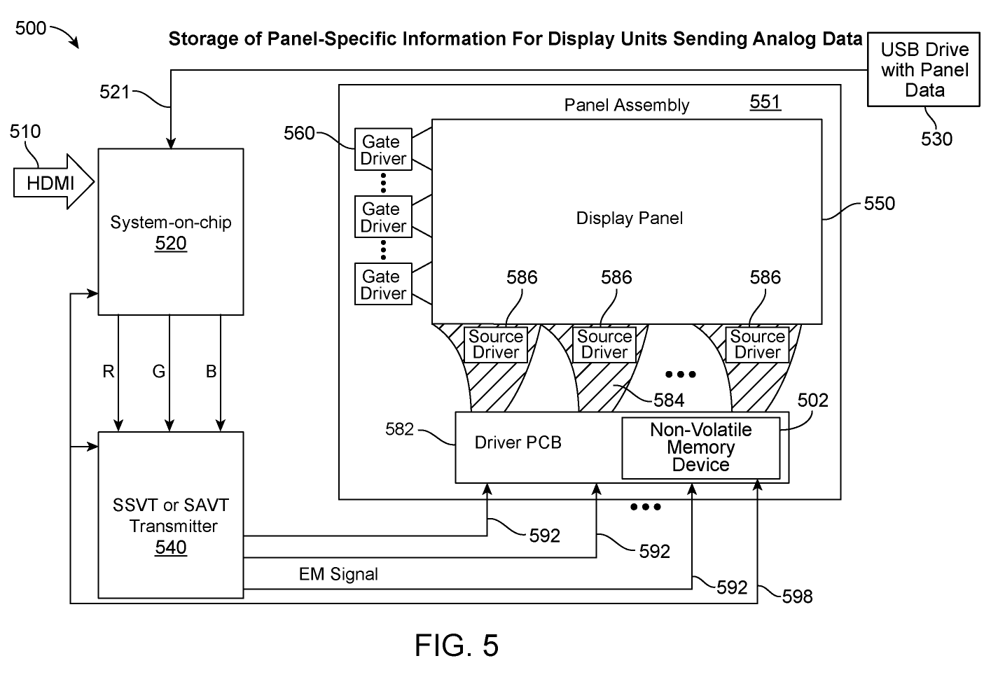

FIG. 5 is a block diagram of a display unit 500 in which analog data is sent to the source drivers from a transmitter 540. Similar to the display unit of FIG. 2, shown also is a display panel 550 of a panel assembly 551 of the display unit 500, gate drivers 560 and a digital video signal 510 being delivered to the display unit using an HDMI interface (an LVDS, HDBaseT, MIPI, IP video, etc., interface may also be used). Shown generally is the system-on-chip (SoC) 520 which receives the digital video samples from the input video signal. In this example of FIG. 5, the display panel 550 may be a display panel of any size such as a monitor, large-screen television, billboard, scoreboard, computer, tablet or telephone display, or may be a display or displays within a VR headset, etc. Included are a driver PCB 582 as well as individual flexible PCBs 584 each holding a source driver 586 which generate source voltages for the display panel. Gate drivers 560 may be implemented as known in the art and generation of the gate driver control signals (not shown) may be performed by the timing controller as is known in the art (or by other specific hardware) and may be based on synchronization information from the source drivers.

The functionality of the T-Con is now within the SoC (i.e., there is no separate T-Con integrated circuit produced along with the panel assembly) which also performs functions such as reverse compression, etc., and outputs digital video samples (in the RGB color space in this example) to transmitter 540. It is contemplated that a separate and discrete display controller may receive the digital video samples from the SoC 520, and it may be the separate display controller that actually outputs the video signals to the transmitter 540; in this disclosure we simply refer to the SoC 520 as outputting the digital video signals, whether it is an SoC that incorporates a display controller or an SoC that outputs to a separate display controller which then outputs to the transmitter 540. During operation, a stream of digital video samples 510 containing color values and pixel-related information is received from a video source at display unit 500 and delivered to the SoC 520.

Transmitter 540 may be a spread spectrum video transport (SSVT) transmitter in which case it receives incoming sets of digital video samples in a particular color space, distributes these incoming samples into input vectors corresponding to the number of source drivers, encodes each input vector into a series of levels, and outputs each series of levels as analog levels in an electromagnetic signal 592 for delivery to one of the source drivers 586. In this embodiment, each source driver 586 receives a series of analog levels, decodes the series into analog values, and collects the decoded analog values to be driven onto columns of the display panel 550. In this particular embodiment, SSVT transmitter 540 may be implemented as described in U.S. patents Nos. 10,158,396, 11,463,125, 12,176,933, 11,716,114, which are all hereby incorporated by reference (Atty. Dockets Nos. HYFYP001, P002, P003, P004AX1), and source drivers 586 may be implemented as described in U.S. patent Nos. 12,039,951, 11,842,671, which are also all hereby incorporated by reference. Techniques described in U.S. patents 17/851,821, 18/448,330, which are all hereby incorporated by reference may also be used to deliver the electromagnetic signals 592. Although transmitter 540 is shown as being separate from SoC 520, it may be integrated with the T-Con and also with SoC 520 as described in U.S. patent No. 11,769,468, which is hereby incorporated by reference.

Transmitter 540 may also be a sampled analog video transport (SAVT) transmitter in which case it receives incoming sets of digital video samples in a particular color space, distributes these incoming samples into input vectors corresponding to the number of source drivers, converts the samples into analog samples, and outputs a series of analog samples for each input vector as an electromagnetic signal 592 for delivery to one of the source drivers 586. In this embodiment, each source driver 586 receives a series of analog samples and collects the analog samples to be driven onto columns of the display panel 550. In this particular embodiment, SAVT transmitter 540 and source drivers 586 may be implemented as described in U.S. patents 18/442,491, 18/821,542, 18/921,989 which are all hereby incorporated by reference (Atty. Docket Nos. HYFYP015, P015X1, P015X1X1. Transmitter 540 may also be any other suitable transmitter that inputs digital video samples and outputs analog video samples for transport to the panel assembly 551.

A memory device 502 is shown mounted on the PCB 582 and is preferably a non-volatile memory that holds certain panel-specific information as herein described and is used by the display panel or panel assembly manufacturer to store the panel-specific information of which it is aware. In this fashion, memory device 502 may be later accessed by the SoC 520 in order to perform image processing on the incoming video samples without the display panel manufacturer concerning itself with the logistics of transferring that information to a separate party nor with confidentiality of the information. Memory device 502 may be any non-volatile memory as described above. In this embodiment, gamma correction is not performed within the source drivers and a gamma correction table will be included within the memory device so that gamma correction is performed within the transmitter 540.

As shown, an electromagnetic pathway 598 provides communication between memory device 502 and SoC 520 or transmitter 540. Because panel assembly 551 is manufactured separately, and in a different location, from SoC 520 and the rest of the display unit, pathway 598 may include multiple portions such as is shown in FIGS. 4A and 4B. Using the implementation shown in FIG. 4A, pathway 598 includes an EM pathway 598a on PCB 582 from memory device 502 to a suitable connector 522 on PCB 582, an EM pathway 598b on a main board on which SoC 520 is mounted that connects that SoC to a suitable connector 512 on the main board, and a flexible printed circuit cable similar to cable 440 that connects the driver PCB 582 to the main board. If the transmitter 540 is integrated within SoC 520 then a cable similar to cable 440 may be used to transmit the memory device data and the video samples. If not, then a cable as shown in FIG. 4A may be used to connect the memory device to the system-on-chip and a separate interface cable may be used to connect transmitter 540 to panel assembly 551 in order to transport the analog samples from transmitter 540.

Thus, in an embodiment in which transmitter 540 is a discrete chip, then the memory device may connect directly to the system on-chip and the transmission of the analog samples will be from the transmitter 540 to the panel assembly 551. Alternatively, device 502 may connect directly to transmitter 540, in which case the data in the device 502 may be read and implemented by the transmitter 540. Further transfer of the information of device 502 may also take place through a communication line or lines between 520 and 540.

Or, using the implementation shown in FIG. 4B, driver PCB 582 includes a pathway from memory device 502 to a connector on the PCB 582, a main board on which SoC 520 is mounted includes a pathway from SoC 520 to a connector on the main board, and a wire similar to wire 480 connects the driver PCB 582 to the main board. In this implementation, a separate interface cable for transmission of the analog samples will connect either to system-on-chip 220 (if transmitter 540 is integrated within the system on-chip) or will connect to the transmitter 540 if it is a discrete chip.

During the final assembly of the display unit, the memory device 502 is connected to SoC 520 by connecting either the cable or the wire to the driver PCB and the main board using the connectors. Or, device 502 may be connected to the transmitter 540 using similar connection methods.

In a further embodiment, instead of using memory device 502 in order to store the panel-specific information, the panel assembly manufacturer stores the panel-specific information on a USB drive 530 (also referred to as a flash drive, thumb drive, memory stick, etc.), generally, any small, portable non-volatile memory device that can store the panel-specific information and then be transported to the display unit manufacturer for final assembly. Or, instead of a USB drive 530, the panel assembly manufacturer stores the panel-specific information into an electronic file of a computer which is then transported, sent or delivered via electronic mail, file transfer, uploading and downloading, etc. to the display unit manufacturer. Once the panel data is stored on drive 530 and shipped 521 to the display unit manufacturer, during final assembly the manufacturer reads the panel data from drive 530 (or from an electronic file, as the case may be) and stores the applicable tables into the SoC, with the timing controller functionality or within transmitter 540 as described herein. In this embodiment, the connections of FIG. 4A and 4B are not needed.

FIG. 6 is a block diagram showing the various tables and data that may be stored within memory device 502. A serial interface 598 may be used to access each of the tables and data 620, 630, 640, 650 or 660 within the memory device in order to transfer the data of each table to the SoC 520 when requested. Such an interface and its method of access may be implemented as known to those of skill in the art. Tables 620-650 are described above. Gamma correction table 650 includes gamma correction data and is typically stored in the form of a lookup table (LUT) or similar structure. This LUT contains pre-computed values that map input pixel intensities to output brightness levels according to the desired gamma curve. Gamma correction involves transforming the input values (e.g., 8-bit or 10-bit digital pixel values) into adjusted output values based upon the gamma curve. The table (or LUT) stores these pre-calculated mappings, which a display controller, SoC or other image processor uses during operation. During this image processing, the input pixel values are referenced against the table to retrieve the corresponding corrected output values.

### Flow Diagram

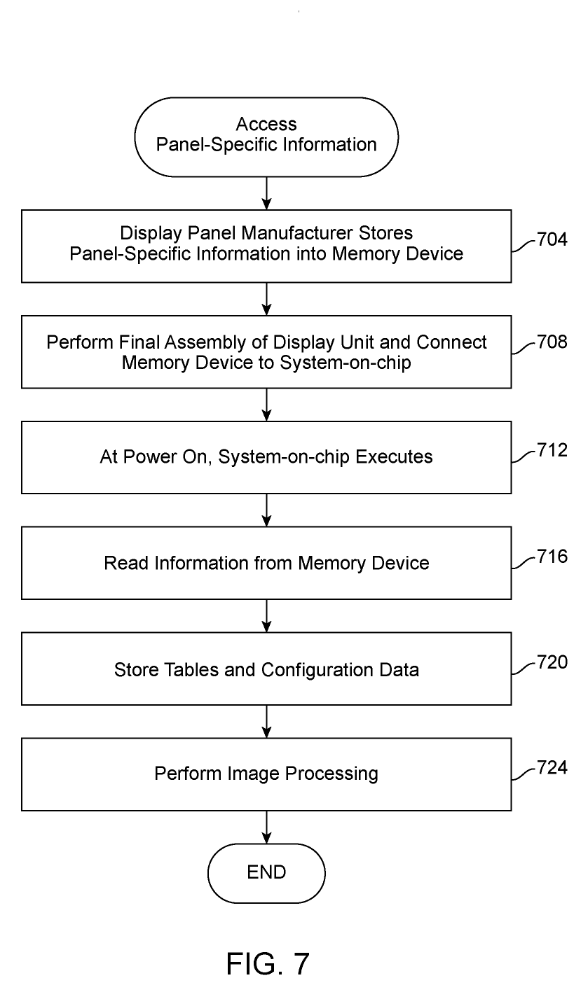

FIG. 7 is a flow diagram describing an embodiment in which panel-specific information is made available to a system-on-chip of a display unit. In a first step 704, a display panel manufacturer in the course of manufacturing panel assembly 251 or 551, for example, stores panel-specific information into either memory device 202 or 502 as the case may be. In the case of panel assembly 251 the memory device may include the panel-specific information such as is shown in FIG. 3 (excluding gamma correction data which may still be stored in association with source drivers 286), while in the case of panel assembly 551 the memory device may include the panel-specific information shown in FIG. 6 which includes the gamma correction data. The stored panel-specific information may be only a single table, a single data item, or any combination of the tables and data described herein. It is contemplated that the minimal data to be stored is the panel resolution, although it is possible that manual input of that resolution may be used at the final assembly in which it may not be necessary to store the panel resolution. For SAVT or SSVT transmitters, it is contemplated that the minimum data to be stored is the gamma correction table. Of course, other tables and data may be stored as well.

In the embodiment in which USB drive 230 or 530 is used, the panel-specific information is stored onto that drive or into the electronic file. Then, as part of step 704, this USB drive or electronic file is shipped to the display unit manufacturer for final assembly.

Once the panel assembly and the rest of the display unit have been united in a single facility (again, the display unit including the main board, system-on-chip, transmitter), in step 708 final assembly of the display unit is performed in which the panel assembly and its corresponding system-on-chip are electrically connected and then manufacture of the display unit is later completed. The memory device 202 or 502 as the case may be is then electrically connected to its corresponding system-on-chip using the techniques of FIG. 4A or FIG. 4B or using similar connection techniques. In the USB drive embodiment, in this step the manufacturer electrically connects the USB drive (or the electronic file) to the SoC.

In step 712, at power-on of the display unit the system-on-a-chip reads its own bootstrap file, begins execution of its program (including instructions on how to read from the memory device), and will read all the panel-specific information from its corresponding memory device 202 or 502. This reading of the memory device may occur at the very first power-on of the display unit (or of its components), at any subsequent power-on, during testing at the manufacturing facility, or at any later time. In the USB drive embodiment, the panel-specific information is read from the USB drive or electronic file and downloaded to the SoC. Alternatively, the panel-specific information may be read from the USB drive and downloaded to the SoC before the SoC is mounted in the display unit and powered on.

In step 716 the panel-specific information is read from the memory device (or from the USB drive or electronic file in that embodiment) and delivered to the system-on-a-chip over the electromagnetic pathway. Next, in step 720, the SoC stores this panel-specific information into appropriate locations within the SoC, within the timing controller (functionality integrated with the system-on-a-chip, or on a separate chip located in close proximity), or within transmitter 540. For example, the panel defect table 320 or 620 is stored in the SoC in its appropriate location, the Mura correction table 330 or 630 is stored within the SoC as well, the sub-pixel correction table 340 or 640 may be stored in transmitter 540, and the gamma correction table 650 (in the case of SoC 520) is stored within transmitter 540. It is contemplated that the gamma correction table preferably be stored in transmitter 540 as this is where it will be used, although for an embodiment in which line 598 only connects to SoC 520, the data of this table 650 may pass through the SoC on the way to the transmitter. At a later stage, when the transmitter is integrated with the SoC, the SoC may absorb this function. Other panel-specific information such as panel resolution and timing data will be stored within the TCON (which may be integrated with SoC 520 or with transmitter 540) or may be stored in the SoC.

In step 724 the display unit receives video samples over a suitable connection such as connection 210 or 510, image processing occurs as is known in the art using the panel-specific information that the system-on-a-chip has read from the memory device, and the processed digital or analog samples are then delivered to the display panel 250 or 550 as shown in FIG. 2 or in FIG. 5.

1. A panel assembly intended for a display unit, said panel assembly comprising:
a display panel;
a non-volatile memory device that stores panel-specific information of said display panel, wherein said panel assembly does not include a timing controller;
an electromagnetic pathway connecting said memory device with a connector of said panel assembly, said electromagnetic pathway arranged to communicate data of said memory device to said connector, wherein said connector is arranged to mate with a corresponding connector of an interface from a system-on-a-chip of said display unit, whereby said panel- specific information may be communicated from said memory device to said system-on-a- chip.

2. A panel assembly as recited in claim 1 wherein said panel-specific information is at
least a panel defect table, a Mura correction table or a sub-pixel correction table, and wherein
said panel assembly is arranged to receive digital video samples for display upon said display panel.

3. A panel assembly as recited in claim 1 wherein said panel-specific information is at least a gamma correction table, wherein said panel assembly does not perform gamma correction, and wherein said panel assembly is arranged to receive digital video samples for display upon said display panel.

4. A panel assembly as recited in claim 1 wherein said panel-specific information is at least a gamma correction table, wherein said panel assembly does not perform gamma correction, and wherein said panel assembly is arranged to receive analog video samples for display upon said display panel.

5. A panel assembly as recited in claim 1 wherein said panel-specific information is at least a gamma correction table, wherein said panel assembly does not perform gamma correction, and wherein said panel assembly is arranged to receive encoded analog video samples into decode said encoded analog video samples into analog voltages for display upon said display panel.

6. A display unit comprising:
a panel assembly including a display panel and a non-volatile memory device that stores panel-specific information of said display panel, wherein said panel assembly does not include a timing controller; and
a main board including a system-on-a-chip having timing controller functionality, and an electromagnetic pathway between said panel assembly and said main board arranged to communicate data of said panel-specific information from said memory device to said system-on-a-chip or to said transmitter on said main board.

7. A display unit as recited in claim 6 wherein said panel-specific information is at least a panel defect table, a mura correction table or a sub-pixel correction table, and wherein said system-on-a-chip transmits digital video samples to said panel assembly for display upon said display panel.

8. A display unit as recited in claim 6 wherein said panel-specific information is at least a gamma correction table, wherein said panel assembly does not perform gamma correction, and wherein said system-on-a-chip transmits digital video samples to said panel assembly for display upon said display panel.

9. A display unit as recited in claim 6 wherein said panel-specific information is at least a gamma correction table, wherein said panel assembly does not perform gamma correction, and wherein said system-on-a-chip transmits analog video samples to said panel assembly for display upon said display panel.

10. A display unit as recited in claim 6 wherein said panel-specific information is at least a gamma correction table, wherein said panel assembly does not perform gamma correction, wherein said system-on-a-chip transmits encoded analog video samples to said panel assembly, and wherein said panel assembly decodes said encoded analog video samples into analog voltages for display upon said display panel.

11. A display unit as recited in claim 6 wherein said electromagnetic pathway includes a cable that also transports video samples from said system-on-a-chip to said panel assembly.

12. A display unit as recited in claim 6 wherein said electromagnetic pathway includes at least one wire that communicates said data.

13. A method of accessing panel-specific information in a display unit said method comprising:
connecting one end of a first electromagnetic pathway to a panel assembly of said display unit, said panel assembly including a non-volatile memory device that stores panel- specific information of said display panel and a second electromagnetic pathway connecting said memory device to said first electromagnetic pathway, wherein said panel assembly does not include a timing controller; and
connecting the other end of said first electromagnetic pathway to a main board of said display unit that includes a system-on-a-chip having timing controller functionality, said main board including a third electromagnetic pathway connecting said system-on-a-chip to said first electromagnetic pathway.

14. A method as recited in claim 13 further comprising:
powering on said display unit and reading, by said system-on-a-chip, said panel- specific information from said memory device via said first, second and third electromagnetic pathways; and
storing data from said panel-specific information into said system-on-a-chip.

15. A method as recited in claim 14 wherein said panel-specific information includes at least a mura correction table, said method further comprising:
reading, by said system-on-a-chip, said mura correction table from said memory device via said first, second and third electromagnetic pathways; and
storing data from said mura correction table into said system-on-a-chip.

16. A method as recited in claim 14 wherein said panel-specific information includes at least a gamma correction table, said method further comprising:
powering on said display unit and reading, by said system-on-a-chip, at least said gamma correction table from said memory device via said first, second and third electromagnetic pathways; and
storing data from said gamma correction table into a transmitter located downstream of said system-on-a-chip.

17. A method as recited in claim 14 wherein said panel-specific information includes at least a panel defect table, said method further comprising:
powering on said display unit and reading, by said system-on-a-chip, at least said panel defect table from said memory device via said first, second and third electromagnetic pathways; and
storing data from said panel defect table into a transmitter located downstream of said system-on-a-chip.

18. A method of accessing panel-specific information in a display unit said method comprising:
receiving, in conjunction with final assembly of a display unit, a panel assembly of said display unit that includes a display panel but that does not include a timing controller;
receiving an electronic file or a portable non-volatile storage device that includes panel-specific information of said display panel;
electronically transferring said panel-specific information from said electronic file or from said portable non-volatile storage device into a system-on-a-chip of said display unit; and
storing, by said system-on-chip, said panel-specific information within memory of said system-on-a-chip, whereby image processing may be performed on video samples using said panel-specific information.

19. A method as recited in claim 18 wherein said portable non-volatile storage device is a USB drive, a flash drive, a memory stick or a USB key.

20. A method as recited in claim 18 wherein said panel-specific information is at least a mura correction table, said method further comprising:
electronically transferring said mura correction table from said electronic file or from said portable non-volatile storage device into a system-on-a-chip of said display unit; and
storing, by said system-on-chip, said mura correction table within memory of said system-on-a-chip, whereby image processing may be performed on video samples using said mura correction table.

21. A method as recited in claim 18 wherein said panel-specific information is at least a gamma correction table, said method further comprising:
electronically transferring said gamma correction table from said electronic file or from said portable non-volatile storage device into a system-on-a-chip of said display unit; and
storing, by said system-on-chip, said gamma correction table into a transmitter located downstream of said system-on-a-chip.

22. A method as recited in claim 18 further comprising:
performing, by said system-on-a-chip, image processing on incoming digital video samples using said stored panel-specific information; and
transmitting said processed digital video samples from said system-on-a-chip to said panel assembly.

23. A method as recited in claim 21 further comprising:
performing, by said transmitter, image processing on incoming digital video samples using said stored gamma correction table; and
converting said processed digital video samples into encoded analog samples and transmitting said processed encoded analog video samples from said transmitter to said panel assembly.

24. A method as recited in claim 21 further comprising:
performing, by said transmitter, image processing on incoming digital video samples using said stored gamma correction table; and
converting said processed digital video samples into analog samples and transmitting said processed analog video samples from said transmitter to said panel assembly for display on said display panel.
